(19) United States
(12) Patent Application Publication
(10) Pub. No.: US 2025/0130915 A1
(43) Pub. Date: Apr. 24, 2025

(54) OPTIMZED DATA COLLECTION SCHEDULER

(71) Applicant: DELL PRODUCTS L.P., Round Rock, TX (US)

(72) Inventors: Balasingh Samuel, Round Rock, TX (US); Farzad Khosrowpour, Pflugerville, TX (US); Travis North, Cedar Park, TX (US)

(21) Appl. No.: 18/492,462

(22) Filed: Oct. 23, 2023

(51) Int. Cl. G06F 11/34; G06F 9/48

(52) U.S. Cl. CPC G06F 11/34; G06F 9/4881

(57) ABSTRACT

An information handling system stores data collection policies. An embedded controller creates a data tolerance table and, based on the data collection policies, creates a timer associated with data collection of a first data type identified in one of the data collection policies. The embedded controller determines a data collection duration for the data collection of the first data type. In response to the timer no longer being needed for any of the data collection policies, the embedded processor disables the timer.

### FIELD OF THE DISCLOSURE

The present disclosure generally relates to information handling systems, and more particularly relates to an optimized data collection scheduler in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a memory and an embedded controller. The memory may store a data tolerance table and data collection policies. The embedded controller may create the data tolerance table and receive the data collection policies. Based on the data collection policies, the embedded controller may create a timer associated with data collection of a first data type identified in one of the data collection policies. The embedded controller may determine a data collection duration for the data collection of the first data type. In response to the timer no longer being needed for any of the data collection policies, the embedded processor may disable the timer.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system according to at least one embodiment of the present disclosure;

FIG. 2 is a diagram of a data tolerance policy table according to at least one embodiment of the present disclosure;

FIGS. 3-5 are diagrams of different data collection policy tables according to at least one embodiment of the present disclosure;

FIG. 6 is a diagram of a data collection timer schedule to at least one embodiment of the present disclosure;

FIG. 7 is a flow diagram of a method for configuring a data collection scheduler according to at least one embodiment of the present disclosure; and

FIG. 8 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

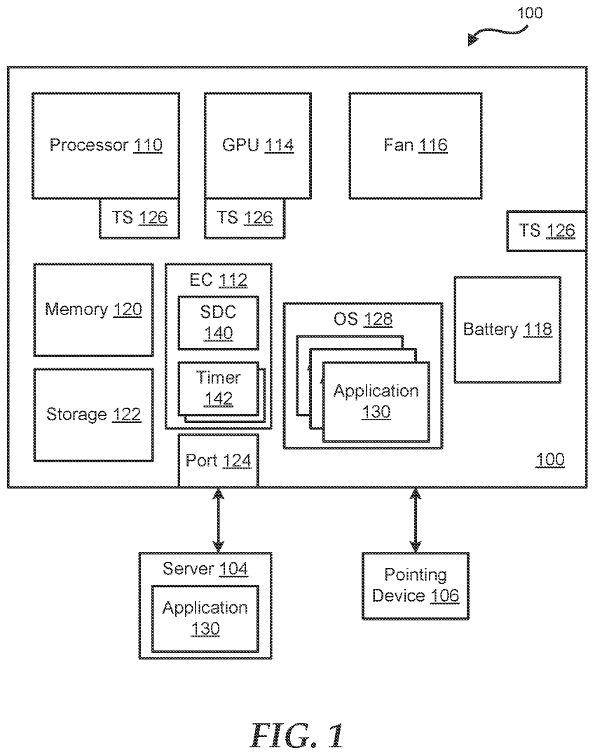

FIG. 1 illustrates a portion of a system 100 including an information handling system 102, a server 104, and a pointing device 106 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110, an embedded controller (EC) 112, a graphics processing unit (GPU) 114, a fan 116, a battery 118, a memory 120, a storage 122, a communication port 124, multiple temperature sensors 126, and an operating system (OS) 128. Server 104 and OS 128 include one or more applications 130, which in turn may request data from components of information handling system 102 as will be described herein. EC 112 includes a system data collection (SDC) service 140 and a timer 142. In certain examples, SDC service 140 may be referred to as a data collection scheduler 140 without varying from the scope of this disclosure. Timer 142 may be a physical timer, such as an incrementing or decrementing counter, or the like, a programmable timer within SDC service 140, or the like. In an example, information handling system 102 may communicate with server 104 via communication port 124 and communicate with pointing device 104 via any suitable communication protocol and interface. Information handling system 102 may include additional components without varying from the scope of this disclosure.

During operation of information handling system 102, EC 112 may execute SDC service 140 to collect data from the other components of the information handling system. In an example, the collected data may be any suitable data, such as a charge of battery 118, different temperatures within information handling system 102, and different data associated with processor 110, GPU 114, cooling fan 116, pointing device 106, memory 120, storage 122, and port 124. SDC service 140 may set data collection tolerances and polices, which may control how data is collected within information handling system 102.

In previous information handling systems, the periodic data collection of a subsystem at a predefined fixed or policy-based frequency may negatively impact system performance. For example, retrieving platform-level data may require CPU cycles and input/output (IO) accesses. In previous information handling systems, multiple applications may request periodic data collection at the same period to provide multiple use cases to the end-user. Information handling system 102 may be improved by optimizing a data collection scheduler to enable multiple collection use cases concurrently.

In an example, application 130 either within OS 128 or running on server 104 may request a data tolerance value from SDC service 140. For example, application 130 may request a tentative start time and duration for a particular data collection policy. In response to the data tolerance value request, SDC service 140 may create a data tolerance table and provide the table to application 130 of OS 128 or to application 130 on server 104. In an example, the data tolerance value may indicate a minimum period between data collection events, a data expiration policy, or the like.

In certain examples, EC 112 may perform any suitable operations to optimize SDC scheduler 140. For example, EC 112 may dynamically optimize the data tolerance of scheduler 140 based on data collection policies currently running within the EC. EC 112 may further optimize data collection scheduler 140 by managing timer 142 within the EC. In an example, SDC scheduler 140 may generate one or more data expiration policies/data tolerance and provide these policies to applications 130 in OS 128 and/or server 104. In certain examples, SDC service 140 may store the generated data expiration policies in a storage, such as storage 122, associated with EC 112.

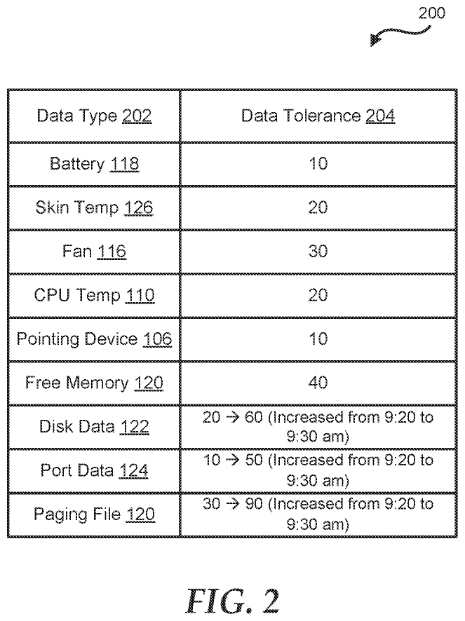

In an example, SDC scheduler 140 may automatically adjust the data expiration policy/data tolerance value. For example, when information handling system 100 is configured for a maximum performance mode, EC 112, via SDC scheduler 140, may extend the data expiration value for data associated with certain subsystems. In an example, if too many data collection rules are already in process, then EC 112 may increase the data tolerance of certain data sets. For example, if three or more applications 130 are collecting data, such as ‘data type 1’, ‘data set 2’, ‘data set 7’, ‘data set 9’, and ‘data set 10’, at periodic intervals, then EC 112 may increase the data expiration of ‘data set 3’, ‘data set 4’, ‘data set 5’, ‘data set 6’, and ‘data set 8’ to the maximum. This change in the data expiration may reduce the performance impact on information handling system 102. In certain examples, applications 130 may validate the periodic data collection. In an example, the validation by application 130 may provide a pre-validating of the data expiration policy before submitting the request to SDC services 140. Exemplary, data tolerance policies and data collection policies for components of information handling system 102 will be described with respect to FIGS. 2-6 below.

FIG. 2 illustrates a data tolerance policy table 200 according to at least one embodiment of the present disclosure. Data tolerance policy table 200 includes a data type column 202 and a data tolerance column 204. In certain examples, data tolerance policy table 200 may be associated with any suitable data of information handling system 100. For example, data type column 202 may include the data to be collected from multiple components of information handling system 100. In an example, the data type may include, but is not limited to, data for battery 118, skin or cover temperature from a thermal sensor 126, data associated with cooling fan 116, data from processor 110, data associated with pointing device 106, an amount of free memory in memory 120, data for storage 122, data associated with port 124, and paging file data from memory 120.

Data tolerance column 204 includes different minimum periods or amount of time between data retrieval for each data type. For example, the data tolerance or period for data associated with battery 118 may be set to ten seconds. The data tolerance or period for data associated with skin temperature measured by temperature sensor 126 may be set to twenty second. In an example, the data tolerance or period for data associated with fan 116 may be set to thirty seconds. The data tolerance or period for data associated with the temperature of processor 110 measured by temperature sensor 126 may be set to twenty second.

In certain examples, the data tolerance or period for data associated with pointing device 106 may be set to ten seconds. The data tolerance or period for data associated with free memory space of memory 120 may be set to forty seconds. In an example, the data tolerance or period for data associated with disk 122 may be set to twenty second. The data tolerance or period for data associated with port 124 may be set to ten seconds, and the data tolerance for data associated with paging file data from memory 120 may be set to thirty seconds. In an example, EC 112 of FIG. 1 may provide data tolerance table 200 to applications 130 of OS 128 and/or server 104. In response to the reception of data tolerance table 200, application 130 may create one or more data collection policies 300, 400, and 500 described below.

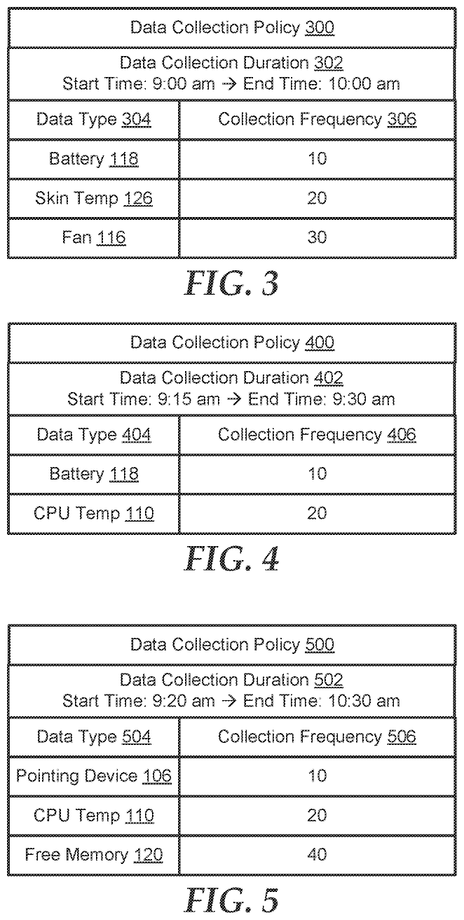

FIG. 3 illustrates a data collection policy 300 according to at least one embodiment of the present disclosure. Data collection policy 300 includes a data collection duration 302, a data type column 304, and a data collection frequency 306. Data collection duration 302 indicates how long data collection policy 300 is active. Each data type 304 identifies different data to be collected. For example, data collection policy 300 controls how data is collected for battery 118, cover temperatures from thermal sensor 126, and fan 116. Data collection frequency 306 may set an interval for how often the data is collected. While specific times and data types will be described with respect to FIGS. 205, one of ordinary skill in the art will recognize that these are merely examples and any suitable times and data types may be utilized without varying from the scope of this disclosure.

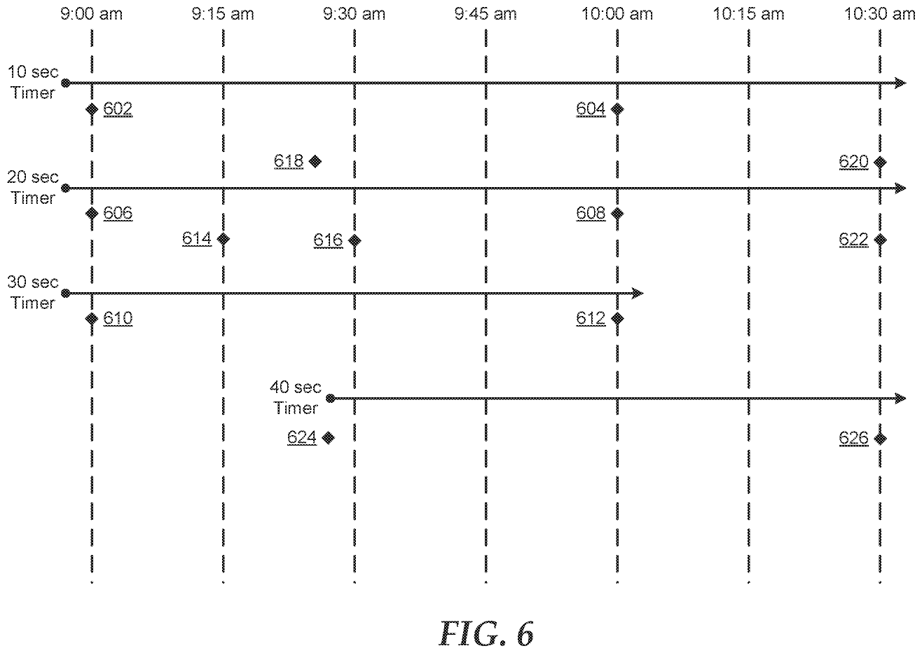

In an example, data collection duration 302 for data collection policy 300 is from 9:00 AM to 10:00 AM. At the beginning of the period identified in data collection duration 302, EC 112 may create one or more timers based on data collection frequencies 306 for data types 304. For example, EC 112, via SDC scheduler 140, may create three timers associated with data collection policy 300. As illustrated in FIG. 3, each of the timers may be associated with a different collection frequency 306. For example, a ten second timer may be created for data collection of data for battery 118. This timer is illustrated in FIG. 6 and is created prior to the start of data collection duration 302, such as before 9:00 AM. In an example, the ten second timer may continue until a data collection policy no longer includes a data collection frequency set at ten seconds.

Referring now to FIG. 6, data collection for data of battery 118 is started at point 602 and ends at point 604. In this example, starting point 602 of battery data collection may be at 9:00 AM and ending point 604 may be at 10:00 AM as identified by data collection duration 302 of FIG. 3. During the time between starting point 602 and ending point 604, EC 112 may collect data associated with the battery 118 every ten seconds as set by collection frequency 306 for the battery.

Referring back to FIG. 3, a twenty second timer may be created for data collection of skin or cover temperatures from thermal sensor 126. This timer is illustrated in FIG. 6 and is created prior to the start of data collection duration 302, such as before 9:00 AM. In an example, the twenty second timer may continue until a data collection policy no longer includes a data collection frequency set at twenty second.

Referring to FIG. 6, data collection of skin or cover temperatures from thermal sensor 126 is started at point 606 and ends at point 608. In this example, starting point 606 of skin or cover temperatures may be at 9:00 AM and ending point 608 may be at 10:00 AM as identified by data collection duration 302 of FIG. 3. During the time between starting point 606 and ending point 608, EC 112 may collect data associated with the cover temperatures from thermal sensor 126 every twenty second as set by collection frequency 306 for the cover temperature.

Referring back to FIG. 3, a thirty second timer may be created for data collection of data associated with fan 116. This timer is illustrated in FIG. 6 and is created prior to the start of data collection duration 302, such as before 9:00 AM. In an example, the thirty second timer may continue until a data collection policy no longer includes a data collection frequency set at thirty seconds.

Referring to FIG. 6, data collection fan 116 may be started at point 610 and end at point 612. In this example, starting point 610 of fan 116 may be at 9:00 AM and ending point 612 may be at 10:00 AM as identified by data collection duration 302 of FIG. 3. During the time between starting point 610 and ending point 612, EC 112 may collect data associated with fan 116 every thirty seconds as set by collection frequency 306 for the fan. EC 112 may determine that data collection policy 300 is the only policy utilizing a thirty second collection frequency. Based on this determination, when data collection duration 302 ends, EC 112 may disable the thirty second timer.

FIG. 4 illustrates a data collection policy 400 according to at least one embodiment of the present disclosure. Data collection policy 400 includes a data collection duration 402, a data type column 404, and a data collection frequency 406. Data collection duration 402 indicates how long data collection policy 400 is active. Each data type 404 identifies different data to be collected. For example, data collection policy 400 controls how data is collected for battery 118 and temperatures of processor 110. Data collection frequency 406 may set an interval for how often the data is collected.

In an example, data collection duration 402 for data collection policy 400 is from 9:15 AM to 9:30 AM. At the beginning of the period identified in data collection duration 302, EC 112 may create one or more timers based on data collection frequencies 306 for data types 304 unless these timers have already been set. For example, EC 112, via SDC scheduler 140, may determine that the two timers associated with data collection policy 300 have already been created based on data collection policy 300 of FIG. 3. As illustrated in FIG. 4, each of the timers may be associated with a different collection frequency 406. For example, the ten second timer may be for data collection of data for battery 118. This timer is illustrated in FIG. 6 and has already been created, such as before 9:00 AM.

Referring now to FIG. 6, data collection for data of battery 118 was already started at point 602 and set to end at point 604. In this example, data collection duration 402, such as 9:15 AM to 9:30 AM, is located within battery data collection duration 302 of FIG. 3, such as 9:00 AM to 10:00 AM. During data collection duration 402, EC 112 may collect data associated with the battery 118 every ten seconds as set by collection frequency 406 for the battery.

Referring back to FIG. 4, EC 112 may determine that a twenty second timer is needed for the temperature of processor 110. EC 112 may determine that the twenty second timer has already been created based on data collection policy 300 of FIG. 3.

Referring to FIG. 6, data collection for the temperature of processor 110 is started at point 614 and ends at point 616. In this example, starting point 614 for the temperature of processor 110 may be at 9:15 AM and ending point 616 may be at 9:30 AM as identified by data collection duration 402 of FIG. 4. During the time between starting point 614 and ending point 616, EC 112 may collect data associated with temperatures of processor 110 every twenty second as set by collection frequency 406.

FIG. 5 illustrates a data collection policy 500 according to at least one embodiment of the present disclosure. Data collection policy 500 includes a data collection duration 502, a data type column 504, and a data collection frequency 506. Data collection duration 502 indicates how long data collection policy 500 is active. Each data type 504 identifies different data to be collected. For example, data collection policy 500 controls how data is collected for pointing device 106, temperatures for processor 110, and free space in memory 120. Data collection frequency 506 may set an interval for how often the data is collected.

In an example, data collection duration 502 for data collection policy 500 is from 9:20 AM to 10:30 AM. At the beginning of the period identified in data collection duration 502, EC 112 may create one or more timers based on data collection frequencies 306 for data types 304 unless these timers have already been set. For example, EC 112, via SDC scheduler 140, may determine that two timers associated with data collection policy 500 have already been created based on data collection policy 300 of FIG. 3 and that one timer has not been created.

As illustrated in FIG. 5, each of the timers may be associated with a different collection frequency 506. For example, collection frequency 506 for pointing device 106 may be ten seconds. Based on collection frequency 506 for pointing device 106, the ten second timer may be utilized for data collection of data for pointing device 106. This timer is illustrated in FIG. 6 and has already been created, such as before 9:00 AM, such that EC 112 does not create a new timer for data collection of pointing device 106. Referring to FIG. 6, data collection for pointing device 106 may be started at point 618 and ends at point 620. In this example, starting point 618 for pointing device 106 may be at 9:20 AM and ending point 620 may be at 10:30 AM as identified by data collection duration 502 of FIG. 5. During the time between starting point 618 and ending point 618, EC 112 may collect data associated with pointing device every ten seconds as set by collection frequency 506.

In certain examples, collection frequency 506 for temperatures of processor 110 may be twenty second. Based on collection frequency 506 for temperatures of processor 110, the twenty second timer may be utilized for data collection of data for temperatures of processor 110. This timer is illustrated in FIG. 6 and has already been created, such as before 9:00 AM, such that EC 112 does not create a new timer for data collection for temperatures of processor 110. Referring to FIG. 6, data collection of temperatures of processor 110 may have already started at point 614. Based on data collection duration 502, EC 112 may determine that end point of the data collection for temperatures of processor 110 may need to be extended to end point of the data collection duration for data collection policy 500, such as 10:30 am. In this example, EC 112 may keep the starting point for temperatures of processor 110 at 9:15 AM but extend the ending point 622 at 10:30 AM as identified by data collection duration 502 of FIG. 5. During the time between starting point 614 and ending point 622, EC 112 may collect data associated with temperatures of processor 110 every twenty second as set by collection frequency 506.

In an example, data collection duration 502 for data collection policy 500 may have the latest ending time, such as 10:30 am. In this example, EC 112 may determine that when data collection duration 502 for data collection policy 500 ends, that the ten and twenty second timers may be disabled or removed from operation in the EC.

Based on data collection policy 500, EC 112 may determine that a forty seconds timer is needed for the data associated with free space in memory 120 and that this timer has not been created. This timer is illustrated in FIG. 6 and is created prior to the start of data collection duration 302, such as before 9:20 AM. In an example, the forty seconds timer may continue until a data collection policy no longer includes a data collection frequency set at forty seconds.

Referring to FIG. 6, data collection of free space in memory 120 is started at point 624 and ends at point 626. In this example, starting point 624 of free space in memory 120 may be at 9:20 AM and ending point 626 may be at 10:30 AM as identified by data collection duration 502 of FIG. 5. During the time between starting point 624 and ending point 626, EC 112 may collect data associated with free space in memory 120 every forty seconds as set by collection frequency 506 for free space in memory. EC 112 may determine that data collection policy 500 is the only policy utilizing a forty second collection frequency. Based on this determination, when data collection duration 502 ends, EC 112 may disable the forty second timer.

In certain examples, EC 112, via SDC scheduler 140, may monitor and determine how many data collections are being made at any given time. In an example, EC 112 may determine the number of data collections based on data collection policies 300, 400, and 500. For example, EC 112 may determine data collection durations 302, 304, and 306 and the number of different data collections being collected during the data collection durations. Based on data types 304, 404, and 504, EC 112 may determine that during a first interval, such as 9:00 AM to 9:15 AM, a first number of data types, such as three data types, may be collected. EC 112 may also determine that during a second interval, such as 9:15 AM to 9:20 AM, a second number of data types, such as four data types, may be collected. In certain examples, EC 112 may continue to determine the number of data types collected during different intervals and determine whether data tolerance table 200 of FIG. 2 may be updated or optimized based on the number of data types being collected.

In an example, EC 112, via SDC scheduler 140, may determine a particular interval, such as 9:20 AM to 9:30 AM, that all of data collection policies 300, 400, and 500 are running or being implemented. EC 112 may determine that during this interval or period SDC scheduler 140 may be performing a lot of data collections, such as six different data types. Based on a high number of data collections, EC 112 may determine that the data tolerance for data types not listed in any of running policies, such as data collection policies 300, 400, and 500, may be increased. In an example, EC 112 may optimize data tolerance table 200 by automatically increasing or throttling the data tolerance of data types not defined in the data collection policies 300, 400, and 500, during the particular interval, such as from 9:20 AM to 9:30 AM.

In certain examples, EC 112 may determine that data types 202 of data tolerance type 20 of FIG. 2 for data of storage 122, data associated with port 124, and paging file data from memory 120 are not in data collection policies 300, 400, and 500. Based on this determination, EC 112 may determine that a new policy may not be able to collect data for these data types. As such, EC 112 may adjust the data tolerance 204 of data for storage 122, data associated with port 124, and paging file data from memory 120. As illustrated in FIG. 2, data tolerance 204 for data associated with disk 122 may be increased from twenty seconds to sixty seconds during the interval of high data collections in data collection policies 300, 400, and 500.

EC 112 may also increase data tolerance 204 for data associated with port 124 from ten seconds to fifty seconds during the interval of high data collections in data collection policies 300, 400, and 500. Additionally, EC 112 may increase data tolerance 204 for data associated with paging file data from memory 120 from thirty seconds to ninety seconds during the interval of high data collections in data collection policies 300, 400, and 500. In certain examples, the increase in data tolerance 204 of

Optimization rule is also customizable by a policy data for storage 122, data associated with port 124, and paging file data from memory 120 may prevent EC 112, via SDC scheduler 140, from collecting too much data. In an example, as the amount or number of data collections is controlled, the resources of information handling system 102 are not consumed merely by data collection operations.

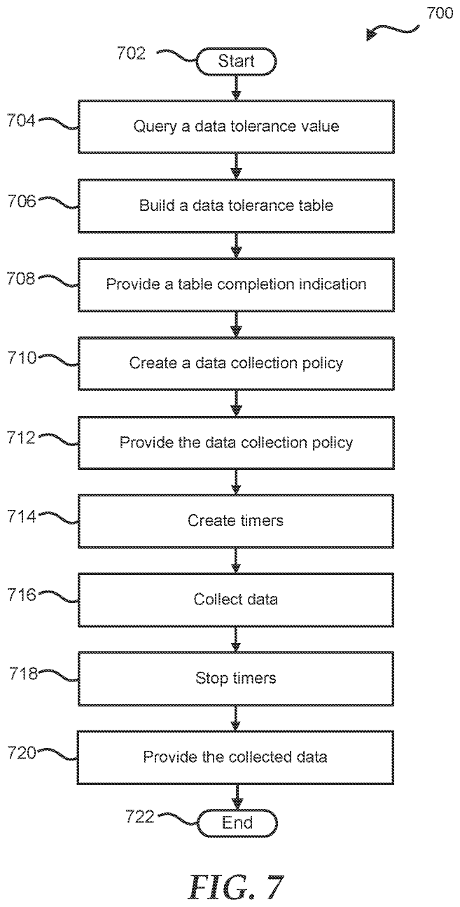

FIG. 7 is a flow diagram of a method for configuring a data collection scheduler according to at least one embodiment of the present disclosure, starting at block 702. In an example, method 400 may be performed by any suitable component including, but not limited to, EC 112 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 704, a data tolerance value is queried. In an example, the data tolerance value query may be from any suitable component associated with an information handling system. For example, an application within the information handling system or an application on a remote server may provide the data tolerance query. In an example, the data tolerance query may be provided to a SDC service/scheduler on an EC of the information handling system.

At block 706, a data tolerance table is built. In an example, the EC, via the SDC service/scheduler, may build or create the data tolerance table by any suitable operations. In certain examples, the data tolerance table may be set or created based on any suitable data collection policy, such as one or more data collection policies currently being executed on the information handling system.

At block 708, a table completion indication is provided. In an example, the table completion indication may be any suitable notification to the applications that the data tolerance table has been completed. For example, the indication may be that the EC provides the created or built data tolerance table to the requesting application, the indication may also be a signal identifying a location that the data tolerance table has been stored, such as a storage device within the information handling system, or the like.

At block 710, a data collection policy is created. In an example, an application either within the information handling system or in an external server, may create a new data collection policy. In certain examples, the new data collection policy may be created based on one or more of the following: a use case within the information handling system; the data tolerance table; a number of data collection policies already created; and a configuration of the information handling system.

At block 712, the data collection policy is provided. In an example, the created data collection policy may be provided from the application to the SDC service/scheduler of the EC. As stated above, the application may be executed within an OS of the information handling system, within an external server, or the like. At block 714, timers are created within information handling system. In certain examples, the SDC service/scheduler of the EC may create the times based on the received data collection policy. In an example, each of the timers may be associated with a different component or data collection point within the information handling system. The creation/starting of timers is represented in FIG. 6.

At block 716, data is collected for different components of the information handling system. In an example, the data is collected based on the data tolerance table and corresponding data collection policies. At block 718, the timers are stopped. In an example, the EC may perform any suitable operations to stop the timers. In certain examples, each timer may be associated with data collection for a different component of the information handling system. Each of the timers may be stopped at different points in time as illustrated in FIG. 6. At block 720, the collected data is provided to one or more applications, and the flow ends at block 722.

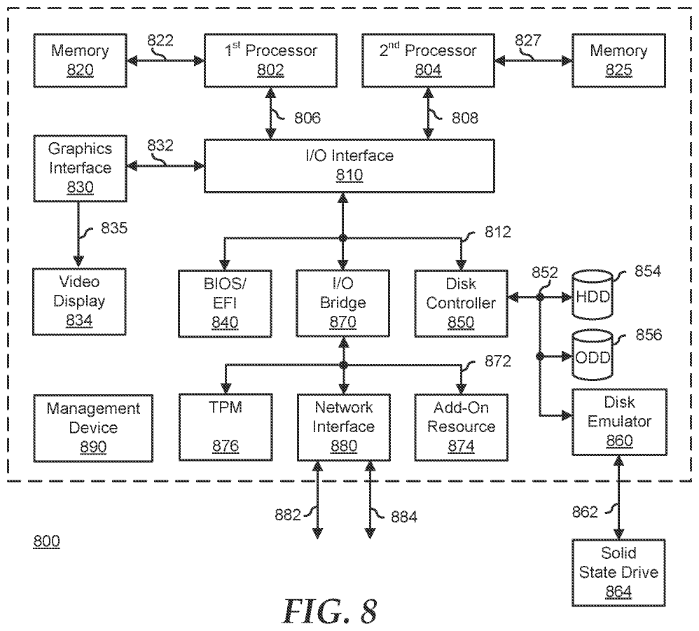

FIG. 8 shows a generalized embodiment of an information handling system 800 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described below and operates to perform one or more of the methods described below. Information handling system 800 includes a processors 802 and 804, an input/output (I/O) interface 810, memories 820 and 825, a graphics interface 830, a basic input and output system/universal extensible firmware interface (BIOS/UEFI) module 840, a disk controller 850, a hard disk drive (HDD) 854, an optical disk drive (ODD) 856, a disk emulator 860 connected to an external solid state drive (SSD) 862, an I/O bridge 870, one or more add-on resources 874, a trusted platform module (TPM) 876, a network interface 880, a management device 890, and a power supply 895. Processors 802 and 804, I/O interface 810, memory 820, graphics interface 830, BIOS/UEFI module 840, disk controller 850, HDD 854, ODD 856, disk emulator 860, SSD 862, I/O bridge 870, add-on resources 874, TPM 876, and network interface 880 operate together to provide a host environment of information handling system 800 that operates to provide the data processing functionality of the information handling system. The host environment operates to execute machine-executable code, including platform BIOS/UEFI code, device firmware, operating system code, applications, programs, and the like, to perform the data processing tasks associated with information handling system 800.

In the host environment, processor 802 is connected to I/O interface 810 via processor interface 806, and processor 804 is connected to the I/O interface via processor interface 808. Memory 820 is connected to processor 802 via a memory interface 822. Memory 825 is connected to processor 804 via a memory interface 827. Graphics interface 830 is connected to I/O interface 810 via a graphics interface 832 and provides a video display output 836 to a video display 834. In a particular embodiment, information handling system 800 includes separate memories that are dedicated to each of processors 802 and 804 via separate memory interfaces. An example of memories 820 and 830 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 840, disk controller 850, and I/O bridge 870 are connected to I/O interface 810 via an I/O channel 812. An example of I/O channel 812 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 810 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 840 includes BIOS/UEFI code operable to detect resources within information handling system 800, to provide drivers for the resources, initialize the resources, and access the resources. BIOS/UEFI module 840 includes code that operates to detect resources within information handling system 800, to provide drivers for the resources, to initialize the resources, and to access the resources.

Disk controller 850 includes a disk interface 852 that connects the disk controller to HDD 854, to ODD 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits SSD 864 to be connected to information handling system 800 via an external interface 862. An example of external interface 862 includes a USB interface, an IEEE 4394 (Firewire) interface, a proprietary interface, or a combination thereof. Alternatively, solid-state drive 864 can be disposed within information handling system 800.

I/O bridge 870 includes a peripheral interface 872 that connects the I/O bridge to add-on resource 874, to TPM 876, and to network interface 880. Peripheral interface 872 can be the same type of interface as I/O channel 812 or can be a different type of interface. As such, I/O bridge 870 extends the capacity of I/O channel 812 when peripheral interface 872 and the I/O channel are of the same type, and the I/O bridge translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as I/O interface 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Management device 890 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 800. In particular, management device 890 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 800, such as system cooling fans and power supplies. Management device 890 can include a network connection to an external management system, and the management device can communicate with the management system to report status information for information handling system 800, to receive BIOS/UEFI or system firmware updates, or to perform other task for managing and controlling the operation of information handling system 800.

Management device 890 can operate off of a separate power plane from the components of the host environment so that the management device receives power to manage information handling system 800 when the information handling system is otherwise shut down. An example of management device 890 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 890 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a data tolerance table and a plurality of data collection policies; and
an embedded controller to communicate with the memory, the embedded controller to:
create the data tolerance table;
receive the data collection policies;
based on the data collection policies, create a timer associated with a data collection frequency of a first data type identified in a first data collection policy of the data collection policies;
determine a data collection duration for the data collection frequency of the first data type; and
in response to the timer no longer being needed for any of the data collection policies, disable the timer.

2. The information handling system of claim 1, wherein the embedded controller further to:
determine a total number of data types for data collection in the data collection policies; and
based on the total number of data types exceeding a threshold number, update the data tolerance table.

3. The information handling system of claim 2, wherein the update of the data tolerance table includes the embedded controller further to:
increase a data tolerance for a second data type in the data tolerance table, wherein the second data type is not a data type identified in the data collection policies.

4. The information handling system of claim 3, wherein the increase of the data tolerance is only for a period of time that the total number of data types exceeds the threshold number, wherein the data tolerance for the second data type is decreased when the period of time expires.

5. The information handling system of claim 1, wherein each of the data collection policies identifies a different collection frequency for each of a plurality of data types identified in the respective data collection policy.

6. The information handling system of claim 1, wherein the embedded controller further to:
determine a second data collection frequency for a second data type in a second data collection policy;
based on the second data collection frequency, determine whether the second data collection frequency matches the created timer; and
if the second data collection frequency does not match the created timer, create a second timer for data collection of the second data type.

7. The information handling system of claim 6, wherein the embedded controller to:
if the second data collection frequency matches the created timer, utilize the created timer for data collection of the second data type.

8. The information handling system of claim 1, wherein the data collection policies are created based on the data tolerance table.

9. A method comprising:
creating, by an embedded controller of an information handling system, a data tolerance table;
storing, by the embedded controller, the data tolerance table in a memory of the information handling system;
based on a plurality of data collection policies, creating a timer associated with a data collection frequency of a first data type identified in a first data collection policy of the data collection policies;
determining a data collection duration for the data collection frequency of the first data type; and
in response to the timer no longer being needed for any of the data collection policies, disabling the timer.

10. The method of claim 9, further comprising:
determining a total number of data types for data collection in the data collection policies; and
based on the total number of data types exceeding a threshold number, updating the data tolerance table.

11. The method of claim 10, wherein the update of the data tolerance table includes the method further comprising: increasing a data tolerance value for a second data type in the data tolerance table in the memory, wherein the second data type is not a data type identified in the data collection policies.

12. The method of claim 11, wherein the increase of the data tolerance is only for a period of time that the total number of data types exceeds the threshold number, wherein the data tolerance for the second data type is decreased when the period of time expires.

13. The method of claim 9, wherein each of the data collection policies identifies a different collection frequency for each of a plurality of data types identified in the respective data collection policy.

14. The method of claim 9, further comprising:
determining a second data collection frequency for a second data type in a second data collection policy;
based on the second data collection frequency, determining whether the second data collection frequency matches the created timer; and
if the second data collection frequency does not match the created timer, creating a second timer for data collection of the second data type.

15. The method of claim 14, further comprising: if the second data collection frequency matches the created timer, utilizing the created timer for data collection of the second data type.

16. The method of claim 9, wherein the data collection policies are created based on the data tolerance table.

17. An information handling system comprising:
a memory to store a data tolerance table and a plurality of data collection policies; and
an embedded controller to:
create the data tolerance table;
based on a plurality of data collection policies, create a timer associated with a data collection frequency of a first data type identified in a first data collection policy of the data collection policies, wherein the data collection policy identifies a collection frequency for the first data type;
determine a data collection duration for the data collection frequency of the first data type;
determine a total number of data types for data collection in the data collection policies;
if the total number of data types exceeds a threshold number, then increase a data tolerance for a second data type in the data tolerance table, wherein the second data type is not a data type in the data collection policies; and
if the timer is no longer needed for any of the data collection policies, then disable the timer.

18. The information handling system of claim 17, wherein the increase of the data tolerance is only for a period of time that the total number of data types exceeds the threshold number, wherein the data tolerance for the second data type is decreased when the period of time expires.

19. The information handling system of claim 18, wherein the embedded controller further to:
determine a second data collection frequency for a third data type in a second data collection policy;
based on the third data collection frequency, determine whether the second data collection frequency matches the created timer, and
if the second data collection frequency does not match the created timer, create a second timer for data collection of the third data type.

20. The information handling system of claim 17, wherein if the second data collection frequency matches the created timer, the embedded controller further to utilize the created timer for data collection of the second data type.
